(19) United States
(12) Patent Application Publication
(10) Pub. No.: US 2015/0268945 A1
(43) Pub. Date: Sep. 24, 2015

(54) INFOTAINMENT SYSTEM KEY FOB ARRANGEMENT FOR A MOTOR VEHICLE

(71) Applicant: Panasonic Automotive Systems Company of America, Division of Panasonic Corporation of North America, Peachtree City, GA (US)

(72) Inventor: HAKAN KOSTEPEN, LOS GATOS, CA (US)

(73) Assignee: Panasonic Automotive Systems Company of America, Division of Panasonic Corporation of North America

(21) Appl. No.: 14/666,811

(22) Filed: Mar. 24, 2015

Related U.S. Application Data
(60) Provisional application No. 61/969,662, filed on Mar. 24, 2014.

(51) Int. Cl. G06F 9/445; G06F 21/32; B60K 37/04

(52) U.S. Cl. CPC G06F 8/65; B60K 37/04; G06F 21/32; B60K 2350/35

(57) ABSTRACT

A method of operating an infotainment system for a motor vehicle includes providing a key fob with a token for a software update for a vehicle function. Infotainment content is transferred from a home computing device to the key fob. The infotainment content is transferred from the key fob to an electronic infotainment device within the motor vehicle.

### CROSS-REFERENCE TO RELATED APPLICATIONS

This application claims the benefit of U.S. Provisional Application No. 61/969,662, filed on Mar. 24, 2014, which the disclosure of which is hereby incorporated by reference in its entirety for all purposes.

### BACKGROUND OF THE INVENTION

1. Field of the Invention

The present invention relates to electronic controls and displays within a motor vehicle, and, more particularly, to electronic controls and displays on a steering wheel of a motor vehicle.

2. Description of the Related Art

Today people carry at least a mobile phone, a key ring (e.g., with house keys) and a wallet with them daily. For car owners, the car key is a fourth item which is carried all of the time. The car key may be replaced or supplemented by an electronic, radio frequency key fob, which is a device which has functions “physically” around the car and these functions are completely car centric. The key fob has no other functions.

A problem with cars in general is that the automotive infotainment electronics products and functions are not easily upgradable, but yet these electronics typically remain in service in the car for ten years or more. This is despite the fact that such consumer electronic products have product cycles of only about two years, after which the consumer would benefit from newer and improved infotainment electronics.

Car Infotainment Systems are in a collision path with mobile devices. Consumers prefer the fast product cycle of the mobile devices and upgrade their mobile devices at a much faster pace than their cars. Consequently, it is very common that consumers are disappointed with their car infotainment systems being outdated as compared to their mobile devices. On the other hand, car makers face a challenge of keeping the car infotainment systems in another product development life cycle than the mobile devices. Currently car original equipment manufacturers (OEMs) are facing the specific challenges below:
Infotainment systems hardware is embedded for the life of the vehicle. Hardware gets outdated within three to five years.
Outdated infotainment systems reduce the vehicle resale value, thus requiring higher car lease payments.
Because infotainment systems are permanently embedded in the car, the hardware is sold only one time. Hardware is not easily upgradable by car makers after the hardware is in the car.
Only upgrading of software is possible.
Infotainment system cost/inventory is deeply integrated with total vehicle cost/inventory.
Because infotainment systems are embedded in the car, driver personalization happens within the vehicle and stays with that specific vehicle.
Dealers need to keep inventory for each infotainment option for the same car because car infotainment systems are embedded in the car. Different levels of infotainment systems drive different levels of vehicle complexity and homologation issues.

As it is becoming more expected and relevant for a car to be communicatively connected to its external environment, most of the connectivity functions are being integrated into the car infotainment systems. Connectivity functions and technologies are also in a fast change path wherein regular updates are called for. Embedded connectivity is another functionality that needs to be updated for the life of the vehicle.

### SUMMARY OF THE INVENTION

The invention may provide a key fob that can serve as an electronic personal identifier/electronic token for key type functions and for “upgradable” multimedia and personalization functions. The invention may partition the vehicle architecture so that wireless connectivity/infotainment functions are separated from the embedded vehicle electronics by virtue of being packaged in the key fob. This enables fast changing electronic functions to be easily upgradable by changing the key fob.

The key fob of the present invention may provide increased security with no need for a password. That is, a mobile device in the form of the key fob may be used in communication with a smart phone for secure transactions without a password. The key fob may be able to detect that it is disposed within or adjacent to a particular vehicle that is known to be owned by a particular person, and thus the key fob can be reasonably assured that it is in the possession of the particular person who owns the car, or at least an agent of the vehicle owner. In order to further increase security for secure electronic transactions, the key fob may positively identify the person who possesses the key fob via fingerprint detection or retina detection.

In one embodiment, the invention comprises a method of operating an infotainment system for a motor vehicle, including providing a key fob with a token for a software update for a vehicle function. Infotainment content is transferred from a home computing device to the key fob. The infotainment content is transferred from the key fob to an electronic infotainment device within the motor vehicle.

In another embodiment, the invention comprises an infotainment system for a motor vehicle, including a key fob which facilitates a software update for a vehicle function, and receives infotainment content from a home computing device. An electronic infotainment device is installed within the motor vehicle and receives the infotainment content from the key fob.

In yet another embodiment, the invention comprises a method of operating an infotainment system for a motor vehicle, including using a key fob to unlock an ignition system of the vehicle and/or unlock a door of the vehicle. The key fob is used to identify a user of the key fob. The key fob is placed in communication with a smart phone that is disposed within the vehicle. The key fob is used to perform a secure transaction for the identified user with the key fob being in communication with the smart phone.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of an infotainment system key fob arrangement of the present invention.

FIG. 2 is a block diagram of another embodiment of an infotainment system key fob arrangement of the present invention.

### DETAILED DESCRIPTION

### Glossary

Connectivity device—an electronic device that facilitates wireless communication between two electronic devices
Connectivity function—a vehicle function that establish communication between two electronic devices
Media function—a vehicle function that utilizes data or content that is stored on an electronic storage medium
Secure—the term “secure” may be used to describe a transaction that cannot be decrypted, deciphered, understood or otherwise used by a third party recipient that is not the intended recipient. The term may also describe a transaction that cannot be interfered with by wireless signals transmitted by a third party who the user does not intend to be involved in the transaction. Further, the term may describe a transaction that one or both of the two electronic devices involved in the transaction allows to take place or be completed only if the user has been identified as someone authorized to conduct the transaction.
Token—a set of bits which represents the right to perform some operation
Vehicle function—a function performed by a vehicle by use of software, such as infotainment functions, including operating an audio system, operating a navigation system, etc.

The embodiments hereinafter disclosed are not intended to be exhaustive or limit the invention to the precise forms disclosed in the following description. Rather the embodiments are chosen and described so that others skilled in the art may utilize its teachings.

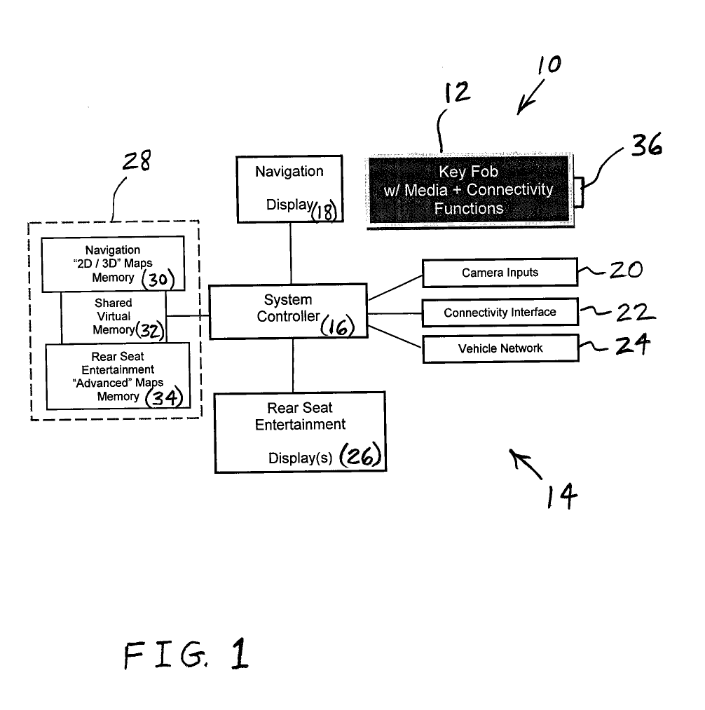

FIG. 1 is a block diagram of one embodiment of an infotainment system key fob arrangement 10 of the present invention, including a key fob 12 communicatively coupled to an in-vehicle infotainment system 14. Key fob 12 has media and connectivity functions, and may function as a smart key for the vehicle in which system 14 is installed. For example, in response to the user actuating a pushbutton (not shown) on key fob 12, key fob 12 may transmit a signal to unlock an ignition system of the vehicle and enable the user to start the engine by pressing another pushbutton on the vehicle. In response to the user actuating yet another pushbutton (not shown) on key fob 12, key fob 12 may transmit another signal to unlock a door and/or a trunk of the vehicle.

System 14 includes a system controller 16, a navigation display 18, camera inputs 20, a connectivity interface 22, a vehicle network 24, rear seat entertainment display(s) 26, and memory device 28. Memory device 28 includes a navigation 2D/3D maps memory 30, a shared virtual memory 32, and a rear seat entertainment advanced maps memory 34.

System controller 16 may have navigation, audio, video and connectivity applications resident, as well as a GPS sensor input. System controller 16 may also be responsible for synchronizing an interface between navigation and connectivity (i.e., location based services) applications, camera applications and rear seat entertainment applications.

Shared virtual memory 32 stores a location based/GPS dynamic data base which links the navigation, camera and rear seat entertainment applications together.

Key fob 12 may store tokens for software updates for vehicle functions, and for establishing secure connections and transactions. A token is a type of two-factor authentication security device that may be used to authorize the use of computer services. In this case, the token stored in key fob 12 may authorize updates of software stored in key fob 12 or stored in the vehicle.

Key fob 12 may store tokens to enable media functions, such as navigation route planning. Key fob 12 may also store tokens to enable portable media, such as portable music players, to communicate with the in-vehicle entertainment system. Key fob 12 may further store tokens to enable memory devices in the vehicle or in key fob 12 to be accessed, retrieved from, or stored to.

Key fob 12 may perform data-only communications, enable wireless connectivity, and run authentication or encryption software to ensure a secure communication connection between key fob 12 and in-vehicle infotainment system 14. Key fob 12 may be capable of wireless communication and connectivity in various forms, such as cellular, Wi-Fi, near field communication (NFC), long term evolution (LTE), and internet connectivity via a secure code.

Key fob 12 may function as a personalization key for all of the owner's (i.e., one person's) cars. That is, key fob 12 may store all of the owner's preferences for all of the owner's cars, and may perform all of the traditional key fob functions for all the owner's cars (e.g., up to ten cars).

Key fob 12 may perform personal identification functions, such as biometrics (e.g., fingerprinting and retinal scans). Key fob 12 may qualify its associated vehicles for insurance discounts due to its ability to identify its owner and thereby prevent others from starting and stealing its owner's cars. The security and biometric functions performed by key fob 12 may enable personalization of the electronics and may accommodate electronic financial transactions.

Key fob 12 may include a G Sensor, which may be in the form of an accelerometer. The G sensor may facilitate a secure self locking feature.

Key fob 12 may enable USB connectivity. More particularly, key fob 12 may include a USB port 36 which enables key fob 12 to be hard-wire connected to in-vehicle infotainment system 14 or to external electronics via a USB cable.

Key fob 12 may enable and control in-car electric battery charging by a charging station or an in-wall receptacle. Similarly, key fob 12 may enable and control charging of in-vehicle solar batteries by the sun.

Key fob 12 may be updated for the life of the car whenever a need arises. For example, key fob 12 may be upgraded every two to five years as the next generation of electronics becomes available.

Key fob 12 may be connected physically or wirelessly to bring infotainment content (e.g., music content, text, navigation maps, image data, audio data, vehicle maintenance schedules, soft media, software updates, store loyalty information and points accumulated in store loyalty programs) to a car, truck, boat or airplane.

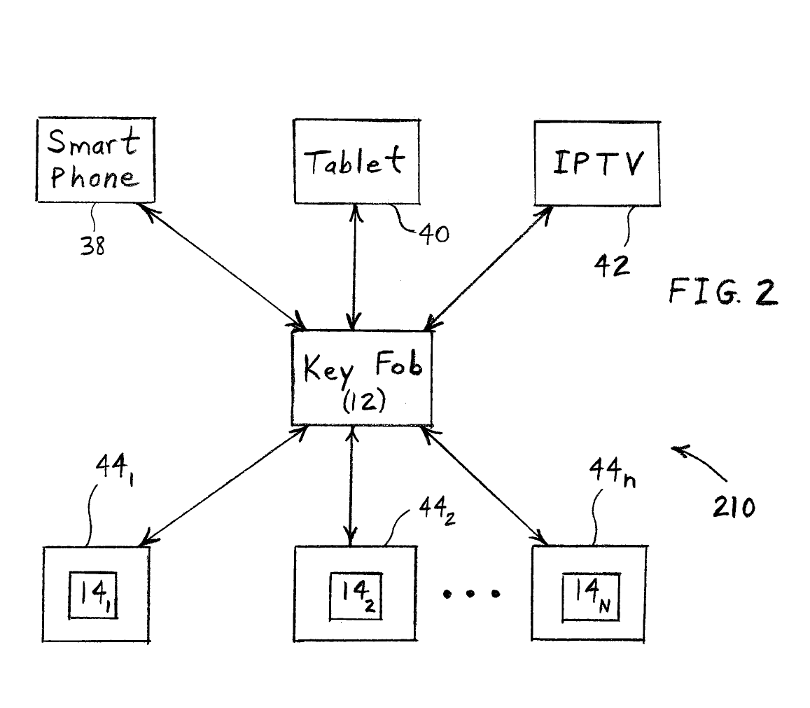

Another embodiment of an infotainment system key fob arrangement 210 of the present invention is shown in FIG. 2, including a key fob 12 bi-directionally communicatively coupled or connected to personal devices such as a smart phone 38, a tablet computer 40 and an internet protocol television 42. Thus, key fob 12 may transport infotainment content in a secure manner from the personal devices to any or all of the vehicles 44₁, 44₂, . . . , 44ₙ belonging to the owner of key fob 12. Each of vehicles 44₁, 44₂, . . . , 44ₙ includes a respective in-vehicle infotainment system 14₁, 14₂, . . . , 14ₙ. Key fob 12 is also bi-directionally communicatively connected to vehicles 44₁, 44₂, . . . , 44ₙ such that key fob 12 may transport infotainment content in a secure manner from vehicles 44₁, 44₂, . . . , 44ₙ to any or all of the personal devices.

Key fob 12 provides a secure way for the owner to carry his digital content. Key fob 12 may carry media upgrades and wireless connectivity functions which can be upgraded every two to five years such that the in-vehicle infotainment systems 14₁, 14₂, . . . , 14ₙ can keep up with the pace of consumer electronics development. Key fob 12 may be programmed for upgrades by the car dealer from which vehicles 44₁, 44₂, . . . , 44ₙ were purchased.

The present invention has been described herein as being applied to a key fob. However, it is to be understood that the invention may also be applied to any wearable device of any existing or emerging technology and of any form factor such as a bracelet, ring, necklace, attachment to a smartphone, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of operating an infotainment system for a motor vehicle, comprising:
providing a key fob with a token for a software update for a vehicle function;
enabling infotainment content to be transferred from a home computing device to the key fob; and
transferring the infotainment content from the key fob to an electronic infotainment device within the motor vehicle.

2. The method of claim 1 wherein the vehicle function comprises a media function or a connectivity function.

3. The method of claim 1 wherein the home computing device comprises a smart phone, a tablet computer, or an internet protocol television.

4. The method of claim 1 wherein the electronic infotainment device within the motor vehicle comprises a navigation device, an entertainment device, a camera, or a connectivity device.

5. The method of claim 1 wherein the providing step comprises providing a key fob with a token for a software update for a vehicle function for each of a plurality of vehicles.

6. The method of claim 1 wherein the step of transferring the infotainment content from the key fob comprises transferring the infotainment content from the key fob to each of a plurality of electronic infotainment devices, each electronic infotainment device being within a respective one of a plurality of motor vehicles.

7. The method of claim 1 comprising the further step of using the key fob to identify a user of the key fob.

8. The method of claim 7 wherein the identifying step includes fingerprinting the user or performing a retinal scan of the user by use of the key fob.

9. The method of claim 7 comprising the further step of using the key fob to perform a secure transaction for the identified user.

10. The method of claim 9 wherein the secure transaction is performed without a password being entered by the identified user.

11. The method of claim 9 wherein the home computing device comprises a smart phone, the secure transaction being performed with the key fob being in communication with the smart phone.

12. The method of claim 1 wherein the vehicle function comprises a battery charging function.

13. An infotainment system for a motor vehicle, comprising:
a key fob configured to:
facilitate a software update for a vehicle function; and
receive infotainment content from a home computing device; and
an electronic infotainment device configured to be installed within the motor vehicle and to receive the infotainment content from the key fob.

14. The system of claim 13 wherein the key fob includes a token for facilitating the software update for the vehicle function.

15. The system of claim 13 wherein the electronic infotainment device comprises a navigation device, an entertainment device, a camera, or a connectivity device.

16. The system of claim 13 wherein the home computing device comprises a smart phone, the key fob being configured to:
identify the user by fingerprinting the user or performing a retinal scan of the user; and
perform a secure transaction for the identified user with the key fob being in communication with the smart phone.

17. The system of claim 13 wherein the key fob is configured to:
transmit a first signal to unlock an ignition system of the vehicle; and
transmit a second signal to unlock a door and/or a trunk of the vehicle.

18. A method of operating an infotainment system for a motor vehicle, comprising:
using a key fob to unlock an ignition system of the vehicle and/or unlock a door of the vehicle;
using the key fob to identify a user of the key fob;
placing the key fob in communication with a smart phone that is disposed within the vehicle; and
using the key fob to perform a secure transaction for the identified user with the key fob being in communication with the smart phone.

19. The method of claim 18 wherein the key fob is used to identify the user by fingerprinting the user or performing a retinal scan of the user by use of the key fob.

20. The method of claim 18 wherein the secure transaction is performed without a password being entered by the identified user.
